(19) United States
(12) Patent Application Publication
(10) Pub. No.: US 2011/0046876 A1
(43) Pub. Date: Feb. 24, 2011

(54) System of Finding Objects and Information on a Map View and Routes on the Map View

(75) Inventors: Li Pan, Antioch, CA (US); Yu Pan, Antioch, CA (US)

Correspondence Address: Li Pan;Yu Pan, 5129 Union Mine Drive, Antioch, CA, 94531, US

(73) Assignees: Li Pan, Antioch, CA (US); Yu Pan, Antioch, CA (US)

(21) Appl. No.: 12/545,837

(22) Filed: Aug. 23, 2009

(51) Int. Cl. G01C 21/00; G06F 17/30; G09G 5/00

(52) U.S. Cl. 701/201; 701/200; 345/660; 707/E17.108

(57) ABSTRACT

The invention is a system with methods that make use of publicly available online map systems and personal computers or mobile devices to provide intuitive user interfaces through which users can browse vicinities of their interests and search for objects and information associated with the vicinities with the need of a positioning hardware such as GPS. The vicinities of the objects and information search are determined by users through operating a map view using a web client application of the system. The system constructs geographic coordinates from a map view or from a travel route on the map view, with which the system associates objects and information and from which the system constructs database query statements for finding location specific objects and information.

### BACKGROUND OF THE INVENTION

Internet is a source of useful information, ranging from personal data to public data, from non-commercial to commercial data. Most data can be associated with location information.

Generally location based object and information systems require positioning hardware (eg., GPS) to obtain geographic coordinates of users which the systems can utilize in associating or searching location specific objects and information. However, not everyone can afford to have GPS-equipped devices and not everywhere can such devices work well to identify precise geographic location or, for privacy purpose, to identify only approximate neighborhood of a location.

Users often care about objects and information within specific ranges of their locations, but usually they have little knowledge about how to associate the ranges, which are normally in distance unit, with the coordinates obtained by GPS devices. Besides, users usually have little knowledge about how to convert ranges to programmable search criteria for computers to improve searches for better results.

Contemporary web-based online map systems, such as Google Map and Yahoo Map, provide functions to visualize the bounding areas where users are located or interested through a map view displayed on a “web client” application software such as a web browser. These online map systems also provide convenient user interfaces to map source and destination addresses of a trip to a poly-line travel route and step-by-step driving or walking directions to guide users to destination. However, these map systems do not provide users with any method to specify distance ranges off the routes when users may be interested with objects and information specific for or within vicinities along the routes.

### SUMMARY OF THE INVENTION

The invention relates to a system for finding location specific objects and information around particular vicinities specified by users of the system.

The invention includes a system and methods that utilize online map systems and personal computers with a pointing input device or personal mobile devices with a touchable panel of sufficient size to operate a web application software of the system executed on personal computers or mobile devices to display a map view on which users of the system can browse vicinities of their interests and search for objects and information associated with the vicinities.

The vicinities of the objects and information search are determined by users through operating a map view using the web client.

The system constructs geographic coordinates from a map view or from a travel route on the map view, with which the system associates objects and information or from which the system further constructs database query statements for finding location specific objects and information.

### BRIEF DESCRIPTION OF THE DRAWINGS

Embodiments of the invention will be described in conjunction with the following drawings:

FIG. 1 shows three map views on a web client; the user operates either one of the upper two map views to move himself or herself to a new location on the map view at bottom.

FIG. 2 shows the system with a map view, a travel route, a set of joint bounding rectangles constructed from the route which comprise the areas to search, and coordinates of the bounding rectangles, as well as the control and data flows regarding how the system processes the coordinates to find objects and information that the user may be interested along the route.

FIG. 3 shows a map view that displays the objects and information obtained using the data and control flow example in FIG. 2.

FIG. 4 shows a map view on which a user drags a travel route a few miles to the right to change his or her trip of helping people in need; as a side effect of changing to a new route, the user learns more people whom he or she can help.

FIG. 5 shows the system with a map view and three rectangles; each of the rectangles conceptually represents a bounding area where some object or information is targeted, as well as the control and data flows regarding how the system processes a map view operation of the user to find objects and information that can be delivered to the user.

FIG. 6 shows a map view that displays the information obtained using the data and control flow example in FIG. 5.

### DETAILED DESCRIPTION OF THE INVENTION

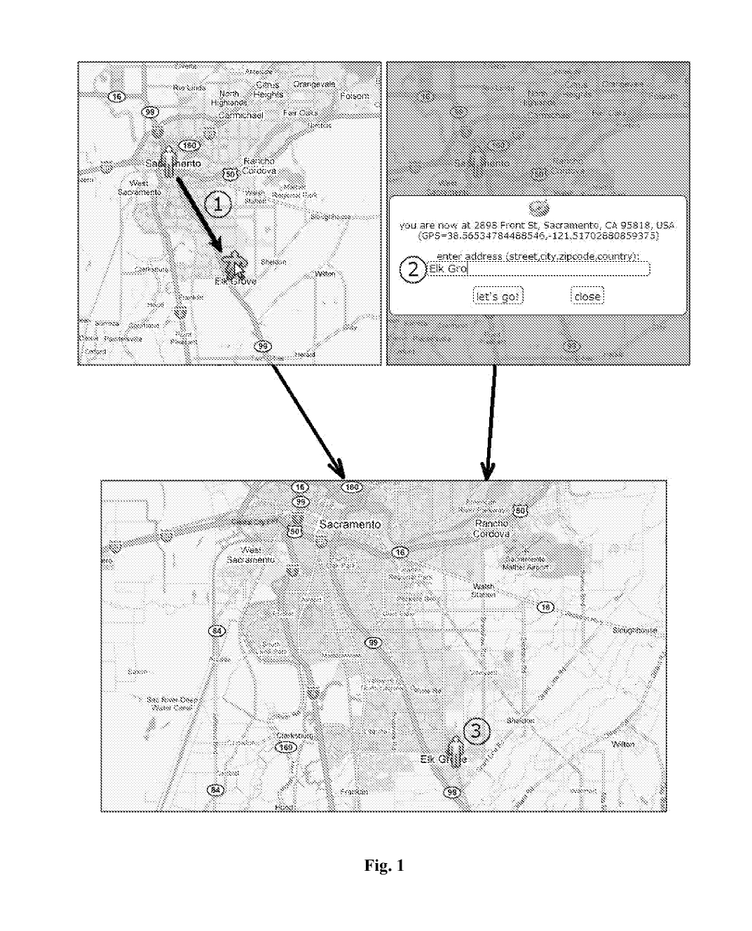

1. The invented system comprises a web application software (“web client”) executed on personal computers and personal mobile devices that can receive and transmit Internet Protocol (“IP”) messages via Internet.
The web client comprises an intuitive graphic user interface and a method for a user of the web client to specify his or her geographic area of interest by operating a map view displayed on a computer or mobile device. With the web client the user browses vicinities of interest and search for objects and information within or associated with the vicinities.
Referring to attached FIG. 1, for example, the user drags a human-shape icon from one place to another (1) on the map view, or he or she types in the exact or approximate address information (2), to change location (3) on the map view.

2. Based on current location of a user, a web client comprises user interfaces (eg. a pop-up dialog) for the user to specify objects and information that he or she associates with the location.
The invented system further comprises a web application software (“web server”) that is executed on a computer that can receive and transmit IP messages via Internet.
The web client then sends coordinates of the location and the specified objects and information in an IP message to a web server of the system via Internet.
When the web server receives the IP message from the web client, the web server constructs a database insertion statement, for example in a “pseudo SQL” syntax below for illustration purpose:
   INSERT INTO TABLE information
      VALUES (coordinates, objects, information);
For the statement above, we assume that there has been a database table named “information” created in a backend database of the system.
The web server then sends the insertion statement in an IP message to backend database server of the system.
The database server then inserts a record containing coordinates of location and specified objects and information into the database.

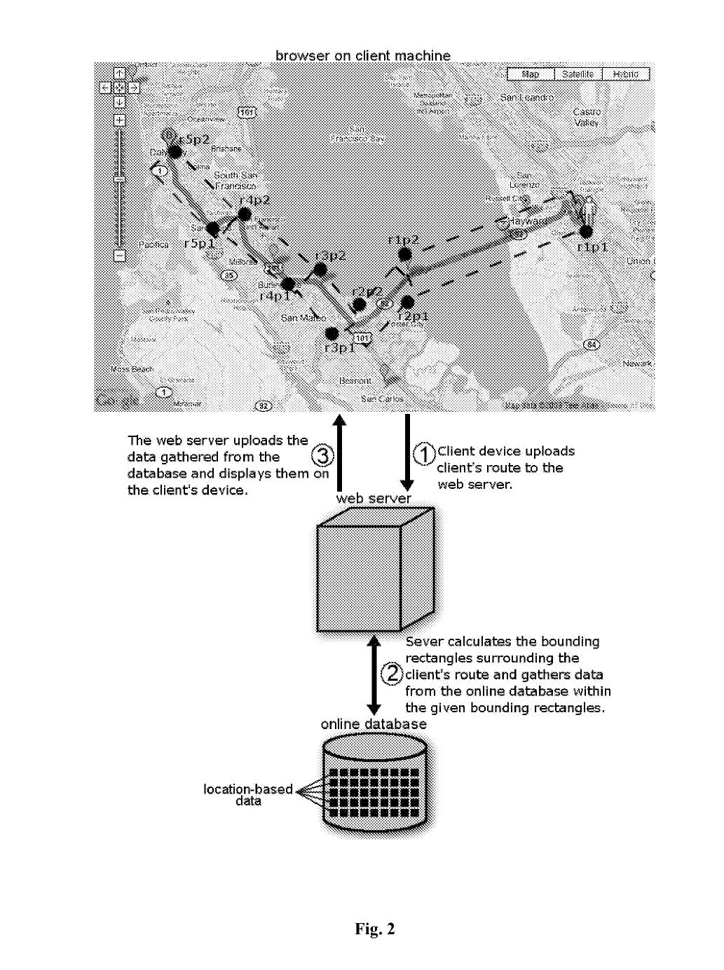

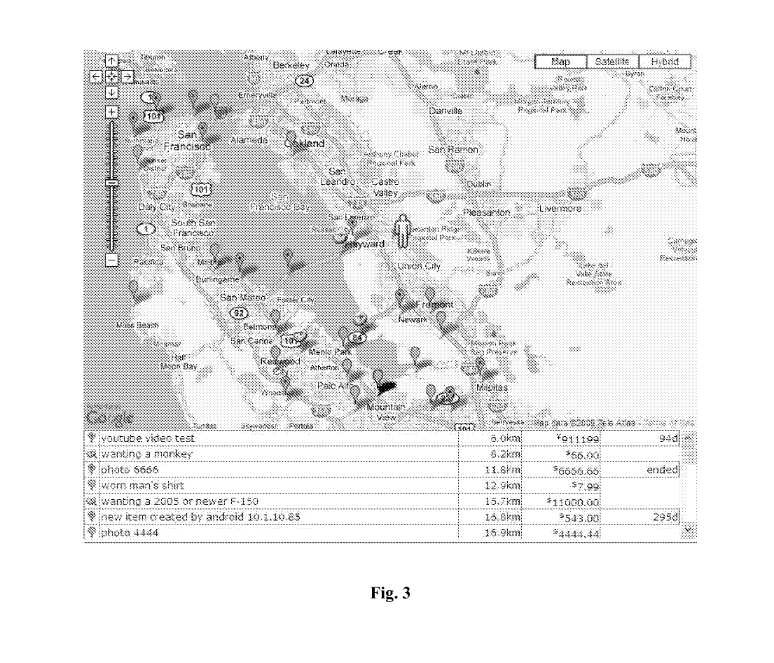

3. Based on current location of a user and a map view shown on web client of the user, the system provides user interfaces (eg. a popup dialog) for the user to specify source and destination addresses of a trip and a distance off a travel route. This way the user specifies one or more joint bounding geographic areas along the route where he or she is interested with objects and information that have been associated with the areas.
With the address information, the system queries online map systems to obtain coordinates of a poly-line corresponding to a travel route of the trip and draws the poly-line on the map view.
Referring to (1) of FIG. 2 attached as an example, the web client then sends coordinates of the poly-line and the specified off-route distance to the web server. The web server converts coordinates of the poly-line and the specified off-route distance into another set of coordinates, eg. [r1p1, r1p2, r2p1, r2p2, r3p1, r3p2, r4p1, r4p2, r5p1, r5p2] in the example, which as shown on FIG. 2 represents the join bounding rectangular areas along the route. Based on the bounding areas, the web server constructs a database query statement, for example in a “pseudo SQL” syntax below for illustration purpose:
   SELECT * FROM TABLE information
      WHERE information.coordinates IS_WITHIN(r1p1,
         r1p2, r2p1, r2p2, r3p1,
         r3p2, r4p1, r4p2, r5p1, r5p2)
The pseudo SQL function IS_WITHIN( ) with the function parameters list (r1p1, r1p2, r2p1, r2p2, r3p1, r3p2, r4p1, r4p2, r5p1, r5p2) shown above is a compound boolean expression of SQL primitive expressions and primitive functions or a predefined SQL stored procedure that performs a series of boolean operations to check whether:
   information.coordinates is within bounding area [r1p1,r1p2], and
   information.coordinates is within bounding area [r2p1,r2p2], and
   information.coordinates is within bounding area [r3p1,r3p2], and
   information.coordinates is within bounding area [r4p1,r4p2], and
   information.coordinates is within bounding area [r5p1,r5p2].
The web server then sends the query statement in an IP message to a backend database server of the system (2).
Objects and information within the bounding areas are then gathered by the database server and sent back to the web server (2).
After possible post-processing the objects and information, the web server sends the objects and information back to the web client (3).
Referring to attached FIG. 3, the web client then displays the objects and information on map by listing individual items in a table or marking each of them with a marker on the map.

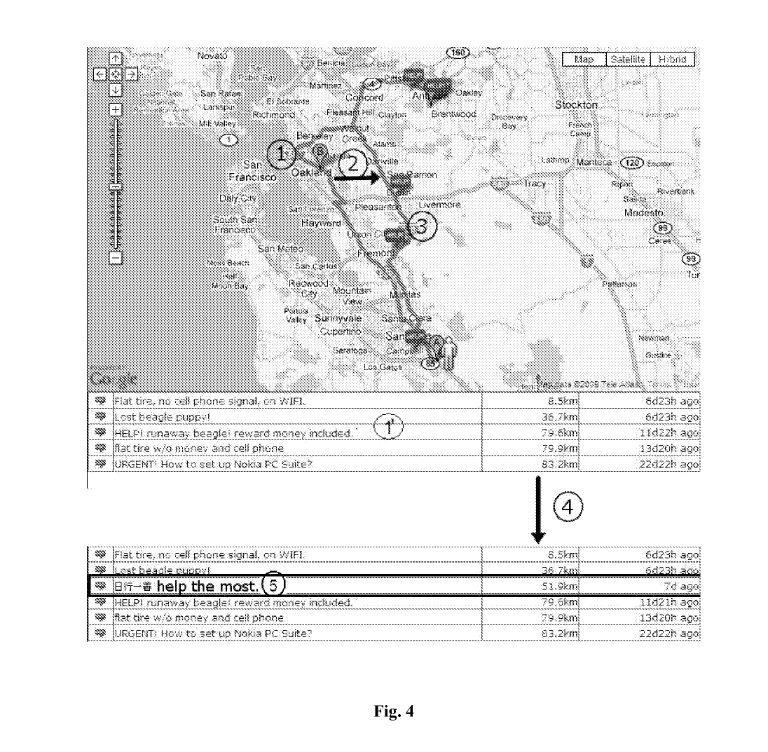

4. The system further comprises a method for users to obtain a different set of objects and information by dragging an existing travel route on a map view to change the route.
Referring to attached FIG. 4 as an example, a user has specified a source (San Jose, Calif.) and destination (Antioch, Calif.) addresses of a trip and the system has displayed the derived travel route (1) as well as objects and information along the route (1′). In this example, the gathered objects and information are “urgent requests for help” posted by five persons along the route.
The method allows the user to use a pointing input device (eg. mouse, track ball or just a finger tip) to drag the existing travel route (1) on the map view (2) to traverse via different geographic locations (3).
With source and destination addresses of the existing route and coordinates of via locations (eg., San Ramon in the example), the system queries online map systems to obtain coordinates of another poly-line, which represents an alternative travel route, and draws the poly-line on the map view (3).
Using the method depicted in section 3 of this description, the web client constructs another set of joint bounding rectangular areas from which the web server constructs a database query statement from which the database server of the system gathers objects and information within the bounding areas (4).
In the example illustrated in FIG. 4, compared with old route, by taking the new route the user gathered one more request for help so that he or she can help one more person during her trip (5).

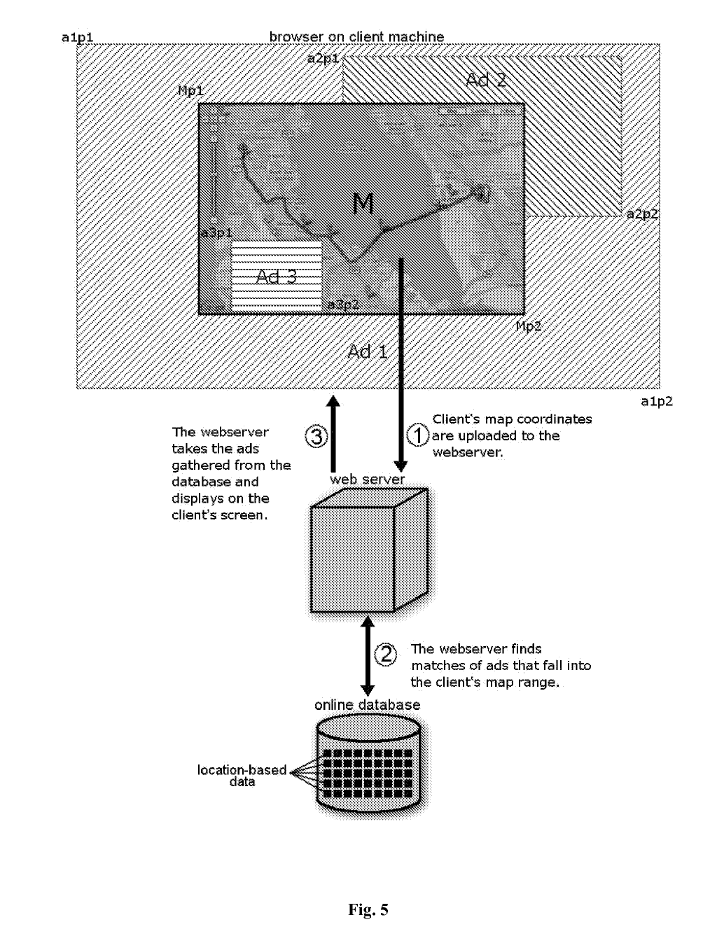

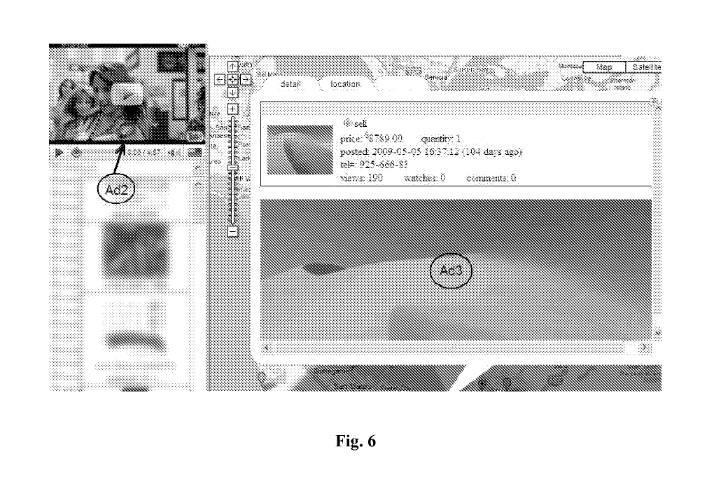

5. The system further comprises a method to find and display objects and information that target at users located within predefined bounding areas.
Referring to FIG. 5 attached for an example, the system stores various objects and information associated with different bounding areas in backend database. Among all stored objects and information, for examples, there are three pieces of objects and information:
   Ad1, associated with coorindates [a1p1, a1p2], indicating that information Ad1 is specific for users in SF Bay Area;
   Ad2, associated with coorindates [a2p1, a2p2], indicating that information Ad2 is specific for users in East SF Bay Area;
   Ad3, associated with coorindates [a3p1, a3p2], indicating that information Ad3 is specific for users in San Mateo county of California;
When a user operates the web client to a bounding map view (M) with coordinates Mp1 and Mp2, the system sends coordinates Mp1 and Mp2 to the web server (1). From Mp1 and Mp2, the web server constructs a database query statement, for example in a “pseudo SQL” syntax form below for illustration purpose,
   SELECT * FROM TABLE information
      WHERE information.bounding_area OVERALAP_WITH
         (Mp1,Mp2)
The pseudo SQL function OVERALAP_WITH( ) is a compound boolean expression of SQL primitive expression and primitive functions or a predefined SQL stored procedure that performs a series of boolean operations to check whether, for each object or information stored in the database, bounding area of the object or information overlaps the bounding rectangle of vertexes Mp1 and Mp2.
The web server sends the query statement to the backend database server (2).
Information and objects associated with a bounding area that overlaps entirely or partially with or is contained in the bounding rectangle of vertexes Mp1 and Mp2 is then gathered by the database server and sent back to the web server (2). In the example, information Ad1, Ad2 and Ad3 are returned to the web server.
After post-processing the objects and information, the web server sends the objects and information back to the web client (3).
Referring to attached FIG. 6, the web client chooses to display some or all of the returned information, shown as (Ad2) and (Ad3).

What is claimed is:

1. An information system that searches and displays location specific objects and information without need of a positioning hardware such as GPS.

2. The information system of claim 1, further comprising a web client that is a web application software executed on a personal computer or mobile device.

3. The web client of claim 2, further comprising a graphical user interface and a method that displays a map view and allows a user to zoom and pan the map view to change geographic bounding areas of interest of the user.

4. The web client of claim 2, further comprising a method for a user to operate an icon on a map view to indicate geographic location of the user.

5. The web client of claim 2, further comprising a method that constructs geographic coordinates of bounding area of interest of a user from coordinates of bounding rectangle of a map view on the web client of the user and sends the constructed coordinates to a web server of the system via Internet.

6. The web client of claim 2, further comprising a graphical user interface and a method for a user to specify source and destination addresses of a trip as well as a distance off travel routes of the trip.

7. The web client of claim 2, further comprising a method that queries online map systems for geographic coordinates of a travel route of a trip with specified source and destination addresses and draws the travel route on a map view.

8. The web client of claim 2, further comprising a method that sends geographic coordinates of a travel route on a map view and a distance off the travel route to a web server of the system via Internet.

9. The information system of claim 1, further comprising a web server that receives geographic coordinates of a travel route and a distance off the route from Internet.

10. The web server of claim 9, further comprising a method that constructs geographic coordinates of joint bounding areas from geographic coordinates of a travel route and a distance off the route.

11. The web server of claim 9, further comprising a method that constructs database query statements from geographic coordinates of joint bounding areas and sends the database query statements to a database server of the system via a private network or Internet.

12. The web server of claim 9, further comprising a method that receives database query results from a database server via a private network or Internet and sends the query results to a web client of the system via Internet.
